(19) United States
(12) Patent Application Publication
(10) Pub. No.: US 2010/0239402 A1
(43) Pub. Date: Sep. 23, 2010

(54) System and method for cargo handling

(76) Inventor: Gorm-Harald Holmedal, Bergen (NO)

Correspondence Address: ABELMAN, FRAYNE & SCHWAB, 666 THIRD AVENUE, 10TH FLOOR, NEW YORK, NY, 10017, US

(21) Appl. No.: 12/661,120

(22) Filed: Mar. 10, 2010

(30) Foreign Application Priority Data
Mar. 18, 2009 (NO) 20091165

(51) Int. Cl. B65G 67/00

(52) U.S. Cl. 414/573; 414/809

(57) ABSTRACT

A cargo storage for handling of cargo such as containers, comprising at least one unloading and loading appliance for unloading and loading of containers from or to a ship, train, truck or the like, and also a framework incorporating one or more movable main cranes for placing and retrieving containers in the cargo storage, and where the framework has outer lanes which are arranged in the at least partially surrounding one or more of the main cranes. Several auxiliary cranes in the outer lanes are arranged to move in parallel adjacent to the direction of movement of the main cranes in the framework, and to receive respective lifting devices, where said outer lanes parallel with the main cranes comprises the transfer points for transfer of the lifting devices between the auxiliary cranes and said main cranes, and that the lifting devices are arranged to circulate in said outer lanes and for a return to a holding location. Also described is an associated system and method.

### BACKGROUND OF INVENTION

1. Field of Invention

The present invention relates to a cargo storage for handling of cargo such as containers, comprising at least one unloading and loading appliance for unloading and loading of containers from or to a ship, train, truck or the like, and also a framework comprising one or more movable main cranes for the placing and retrieving of containers in the cargo storage, and where the framework has outer lanes that are arranged in the at least partially surrounding one or more of the main cranes. The invention also relates to an associated system and method.

2. Brief Description of the Related Art

In connection with transport of cargo, the time a cargo ship is lying in the docks is one of the significant factors affecting the economy and costs. It is therefore desirable to provide a system for the unloading of containers from, for example, a cargo ship, which can streamline this work substantially.

Globalization has resulted in a tremendous increase in the transport of containers by sea. Increased container transport leads to larger container ship, which increases the requirements of the seaport cities, their container terminals and equipment. Whether the container terminals succeed in competition with other terminals depends on a quick handling process, combined with reduced costs. It is therefore necessary to optimize the three main logistic processes at a container terminal: loading and unloading of container ships, storage of containers, and receipt and delivery of containers to and from the trucks.

Ports generate much pollution through the use of diesel trucks and articulated lorries that transport containers to and from ships. The present solution will automate this entire process and the installation can be placed indoors. Unloading of, for example, the ship will go faster and the time for the ship lying at the docks will be reduced. The noise level can be reduced, floodlighting at night-time can be reduced and maintenance costs of equipment can be reduced. Similarly, safety could be increased in the form of fewer accidents and work-related injuries and the risk of break-ins and theft can be reduced. In warmer climates the roof of the building can be utilized for the placement of solar panels. In major ports this could generate environmentally friendly energy that could supply the entire harbour. The present solution will be able to handle a larger volume in an environmentally responsible way and significantly cut down on CO₂ emissions. The solution will be able to move cargo faster and more efficiently, something which will also contribute to lower costs. The solution is suitable for both small terminals and major terminals.

In a typical port warehouse the containers are normally unloaded with the help of one or more cranes standing on land, thereafter the containers are transported to the required storage space with the help of special container trucks. This means that either the unloading crane must wait for the next truck or containers must be placed in a separate cargo storage in anticipation of transfer to the cargo storage.

The present solution is not only intended for use in a port warehouse, as it is flexible and can be used in various types of terminals such as, for example, said port terminals, river terminals or an inland terminal. The main principle of the solution is the flexibility and efficiency of unloading and loading of containers and also the storage of containers in a storage situation. The short-term cargo storage functions as a link between ship, rail and truck. The container will be sent further either on a train, truck or ship. The solution is adapted to the needs for unloading and loading of containers at each individual terminal, and the principle is that all unloading and loading can be carried out automatically to ship, rail or truck.

It is an object of the present invention to produce a cost effective system that significantly facilitates the unloading and loading of containers, and where the system can automatically handle the containers from when they are unloaded and until they are transported further by appropriate means of transport.

From prior art attention is given to US application no. US 2008/0213073, among others, which relates to an unloading system for containers, where the containers are driven from the cargo ship and directly onto trucks, with the help of an overhead framework.

US 2008/213073 A1 is considered to be the closest prior art to the present invention, and relates more specifically to a warehouse handling system for containers, where the containers are preferably transferred directly to trucks or the like or stored in a short-term cargo storage for further transport later. This short-term cargo storage is built with the running rails in a framework shaped like a grid, where the transport units (TU) with equipment to lift the containers run relatively freely in said framework, where the container that is unloaded from the ship is first unloaded and placed on a conveyor belt, and thereafter brought to the desired storage location. The container is picked up by a TU from the conveyor belt, and it is the same unit that brings the container to the desired storage location for further transport. Thus, no cranes are shown in US 2008/213073 A1, but a TU encompassing a lifting unit that moves in a network of rails. A direction change takes place in that one changes wheels by raising or lowering of the wheels at an intersection. Thus a transfer of TU between cranes is not shown.

US 2008/213073 A1 shows no transfer of the lifting device with the container between the various lanes in the framework. As it can be seen in the document, the TU can move in the X-Y plane. This is done in that running rails on the underside are equipped with slits, as explained with reference to FIG. 12. Thus, said TU moves “freely” around the framework. When many TUs are used, a solution as shown in US 2008/213073 A1 requires an advanced management system to keep control of the units that move around in the framework otherwise one runs the risk of collisions, accumulations and delays. In addition, the technical solution in US 2008/213073 A1 limits the speed of the TU to max 20 m/min, something which makes the solution useless in this context.

Thus, one problem that the present invention seeks to resolve in relation to US 2008/213073 A1 is to provide a simpler system, and one that is easier to manage. Said in another way, how to provide a container warehouse comprising a simple crane system and circulating lifting units that make it possible to handle the containers efficiently and quickly and that makes it possible to use an automated handling system for the containers. This is resolved according to the invention in that the smaller auxiliary cranes only move in the outer lanes of the framework, and that the lifting device with the container is transferred to the main cranes lying inside which then place the container at the desired storage location. After the transfer has been carried out, the auxiliary crane returns to a holding location in anticipation of receiving a lifting device and the subsequent retrieval of a new container. Thus, commonly known management systems can be used for the main cranes, at the same time as the auxiliary cranes can be easily managed in the outer lanes.

Reference is also made to US 2008/0025825 and JP52047256.

The disadvantages with the above mentioned document are that one is at all times dependant on access to new trucks. With the present invention, it is intended that the containers are first unloaded and transferred between different cranes ashore to a short-term cargo storage, and thereafter are transported further by ship, train, truck, or other suitable means.

As an example of different solutions for the transfer of cargo, reference is made to JP11299364, U.S. Pat. No. 3,011,455 and US2003/0140816.

None of the above mentioned documents describes a system comprising several lifting units that can circulate in a warehouse with the help of several cranes and a transfer that makes the transfer of the cargo from one crane to another crane possible. With the present invention one makes a saving on time, as the main crane works independently of the auxiliary crane, at the same time as the auxiliary crane lifts a container and has it ready when the main crane is free again. This provides parallel/simultaneous movements that reduce cycle time per container per crane. Another advantage is that the lifting devices move after one another. Overtaking is therefore not possible and one avoids conflict and the system becomes easy to manage. This, in addition to the individual elements being able to reach a speed of 240 m/min (as opposed to 20 m/min as described in US 2008/213073 A1) makes the system very flexible and efficient.

In addition, there is a further object to provide a cargo storage, a system and a method as described above.

### SUMMARY OF THE INVENTION

According to a first aspect of the invention a cargo storage is provided in that several auxiliary cranes in the outer lanes are arranged to be moved in parallel, adjacent to the direction of movement of the main cranes in the framework, and to receive respective lifting devices; that said outer lanes in parallel with the main cranes comprise transfer points for the transfer of the lifting devices between the auxiliary cranes and said main cranes; and that the lifting devices are arranged to circulate in said outer lanes and to return to a holding location.

The outer lane, at the opposite side of the location of the unloading and loading facility, can be arranged to function as a return lane for an empty lifting device to said holding location, in anticipation of a new cycle.

Furthermore, the lifting device can be connected to a carriage arranged in the auxiliary crane, and that in said transfer points, lying between said outer lanes and the main cranes, a transfer device is provided on which the carriage runs for the transfer of the lifting device to or from a main crane.

A container carriage can be arranged to move between a loading point and the unloading and loading facility, for the transfer of the container to or from one of the circulating lifting devices.

Said outer lanes can comprise one or more holding locations for the lifting devices that are waiting to be picked up by a free, smaller auxiliary crane.

Said main cranes and auxiliary cranes can be built as longitudinally running overhead cranes which run in a framework.

Furthermore, the container carriage can be arranged to receive a container arbitrarily placed on the container carriage and to regulate the position of the container on the carriage, or the position of the carriage, so that a container is placed directly below a lifting device for the lifting or lowering.

According to a second aspect of the invention a system is provided for the unloading and loading of containers from or to a ship, train, truck or the like, comprising several cargo storages as described above.

The lifting devices, with or without a load, can be arranged to move between the different cargo storages.

The system can be managed with the help of a suitable management system which can communicate with all the parts of the installation, such as cranes, lanes, carriages, etc.

According to a third aspect of the invention a method is provided for automation and management of loading and unloading of containers from or to a ship, train, truck or the like to a storage facility, in which containers are unloaded or loaded with the help of at least one unloading and loading appliance, and that the containers are transferred to one or more movable main cranes that run in a framework in the storage facility, for the placement and retrieval of a container in a cargo storage, where the framework has outer lanes that are arranged in the at least partially surrounding one or more of the main cranes, comprising the following steps:

placing of the container on a container carriage that is waiting adjacent to the unloading and loading appliance,

moving the container carriage to a waiting auxiliary crane with a lifting device, which is standing at a loading point, where said auxiliary crane is arranged to be moved in the outer lanes in parallel, adjacent to the direction of movement of the main cranes in the framework,

lifting of the container from the container carriage by means of the lifting device,

transferring the lifting device with the container from the auxiliary crane to one of the main cranes, for placing the container in the storage facility, and

after the lifting device has delivered the container to the storage facility, the lifting device is driven out in an auxiliary crane on the outer lane at the opposite side of the loading point, and is returned to a holding location, in anticipation of a new cycle.

While the container carriage is moved back adjacent to the unloading and loading appliance for retrieval of a new container, a new auxiliary crane with a lifting device can be driven up to the loading points to receive a new container.

It is advantageous to record the speed and position of every lifting device, so that the lifting devices can be guided to a desired location at the desired time any time.

For the loading and driving out of the containers the steps described above can be reversed. Alternatively, or in addition, the containers are brought to a selected location in the storage facility for transfer to a ship, train, truck, or the like for loading and despatching of the containers.

### BRIEF DESCRIPTION OF THE DRAWINGS

The invention shall now be described in more detail with the help of the enclosed figures, which schematically show an embodiment example of the invention, in which:

FIG. 1 shows an overview of an example of a storage facility according to the invention.

FIGS. 2 to 10 show in more detail the cycles of the lifting devices in a cargo storage in connection with the unloading of containers.

FIGS. 11 and 12 show transfer of cargo between different cranes.

FIGS. 13 and 14 show, similar to FIGS. 11 and 12, transfer of cargo between different cranes, seen from below.

FIG. 15 shows the driving out of containers for loading from a cargo storage.

FIGS. 16 to 19 show examples of the structure of the modular system according to the invention.

### DESCRIPTION OF PREFERRED EMBODIMENTS

The figures show the unloading of containers from a ship to a storage facility, and where the containers are transported on a truck, train or ship. It must be understood that the system and method according to the invention can also be used in reverse with regards to what is to be explained in the following, and also in other storage facilities than what is shown here. The principle for the solution will be the same whether the unloading and loading is carried out from or to a ship, train, truck or similar transport means.

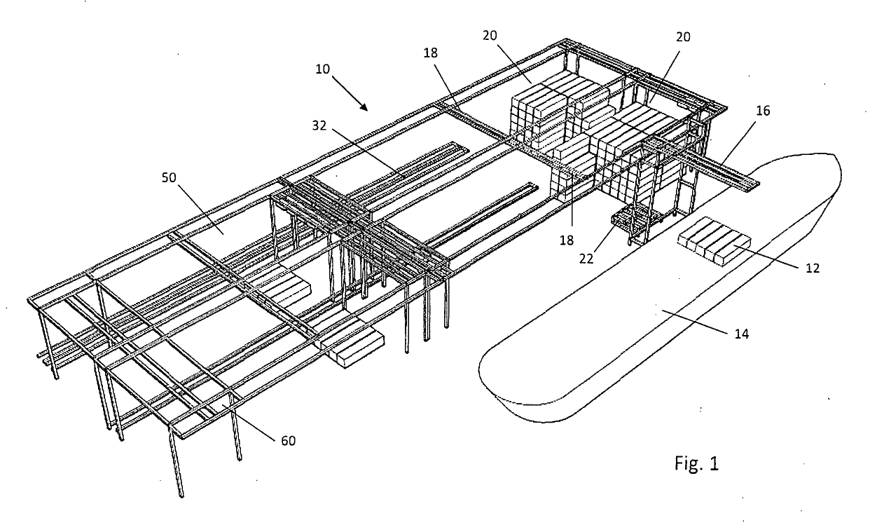

Shown in FIG. 1, as an example of the invention, is a storage facility 10 comprising a cargo storage 20 for unloading and loading, in where said cargo storage can be a short term storage area, a flow-through storage facility 50 and a loading point 60 for loading of, for example, trucks. The storage facility 10 can be built as a raised frame structure with overhead rails on which cranes can run. The construction itself of such a frame structure is considered to be known to a person skilled in the art and will not be described in more detail. The system can also be based on modules and can thus easily be adapted to desired needs. As the system is based on modules, several cargo storages 20 can be placed side by side and/or after one another, and cargo can be transferred between the different cargo storages and, for example, be managed as explained later in this description. The driving out of the containers can also be made from anywhere in the storage facility, and not necessarily from the despatch point as shown in the figures.

Furthermore, FIG. 1 shows a cargo ship 14 that is moored to the quay, where a number of containers 12 which shall be unloaded are on board. This is done with the help of an unloading and loading device such as an unloading crane 16 which transfers the cargo ashore. In the frame structure of the storage installation 10, specifically in a short-term cargo storage 20, a number of main overhead cranes 18 are set up, in the example two overhead cranes are shown, which are arranged to run in the longitudinal direction in the cargo storage 20. Sideways displacement of the cargo is achieved with carriages or trolleys which, in a known way, run in the overhead crane. Overhead cranes are used in the example shown as these are well suited to the intended task, but also other types of cranes can, of course, be used.

The unloading crane which is used can be a so-called STS crane (Ship to Shore crane). The system can be dimensioned and set up for handling of several unloading cranes, but for the sake of simplicity only one STS crane is shown in the FIGS. 1-10. Furthermore emphasis is placed on that the STS crane shall have a fixed point for depositing and collecting containers or other cargo. This is solved in an embodiment example of the present invention in that one or more container carriages 22 are used which are placed in relation to the cranes, so that loading and unloading are made efficient due to the crane operator not needing to be precise with the positioning of the container, for example, if it should be unloaded directly onto a truck. An important feature of the invention is that the container carriage ought to be able to release itself from the container as quickly as possible, so that the container carriage 22 can be driven back to an unloading crane for positioning and collection of a new container while the container is led further with the help of the lifting devices 24, which move in lanes in the storage facility.

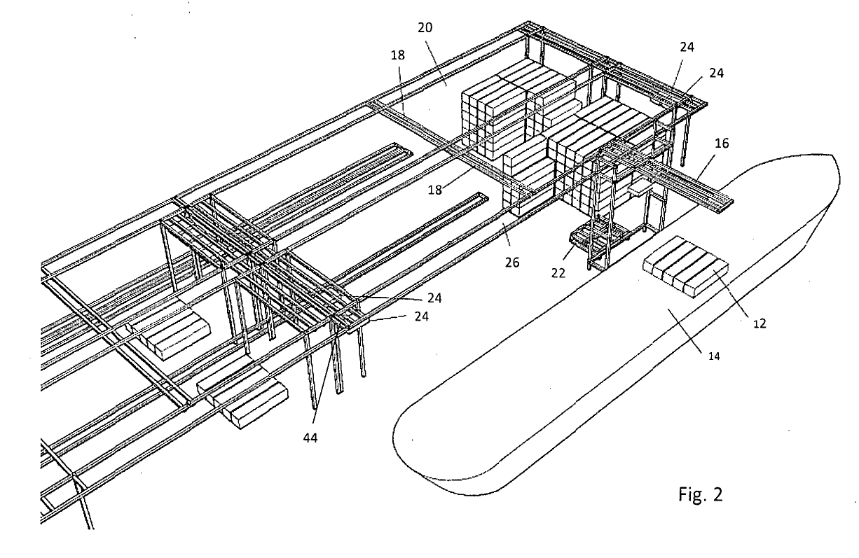

FIG. 2 shows a hypothetical start of the system's cycle. The containers 12 are lying ready on the cargo ship for unloading with the help of the unloading crane 16, and a first lifting device 24 is driven out on a small auxiliary overhead crane 44. The container carriage 22 is also lying ready at the unloading crane 16 for receiving a container 12.

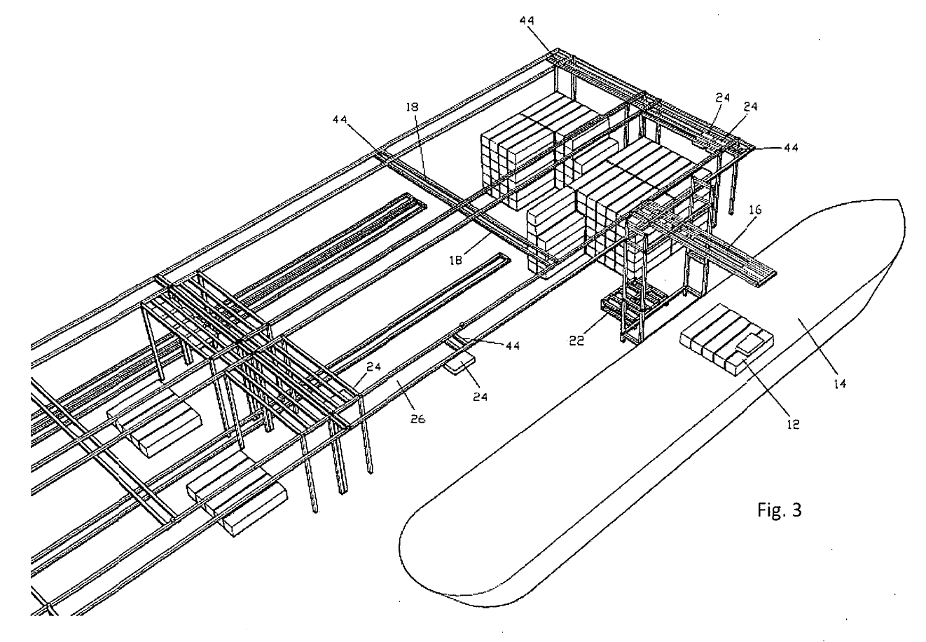

FIG. 3 shows the lifting device 24 which is arranged on the small overhead auxiliary crane 44 and which drives in a lane 26 (from the left) towards a loading point, at the same time as the unloading crane 16 collects a container 12 from the cargo ship 14.

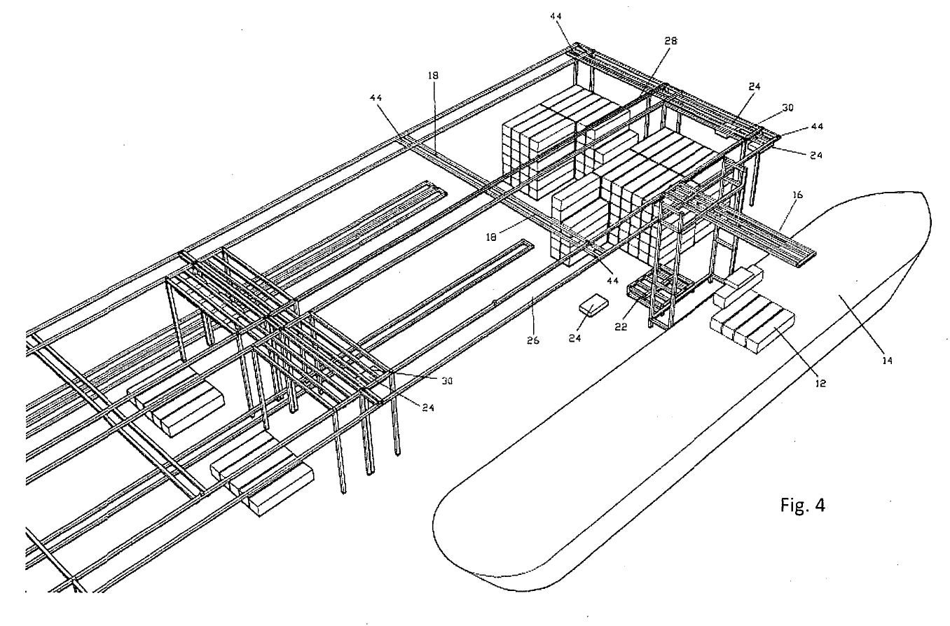

In FIG. 4 the first lifting device 24 has arrived at the loading point and is ready to lift up a container, while a container 12 is transferred to the container carriage 22.

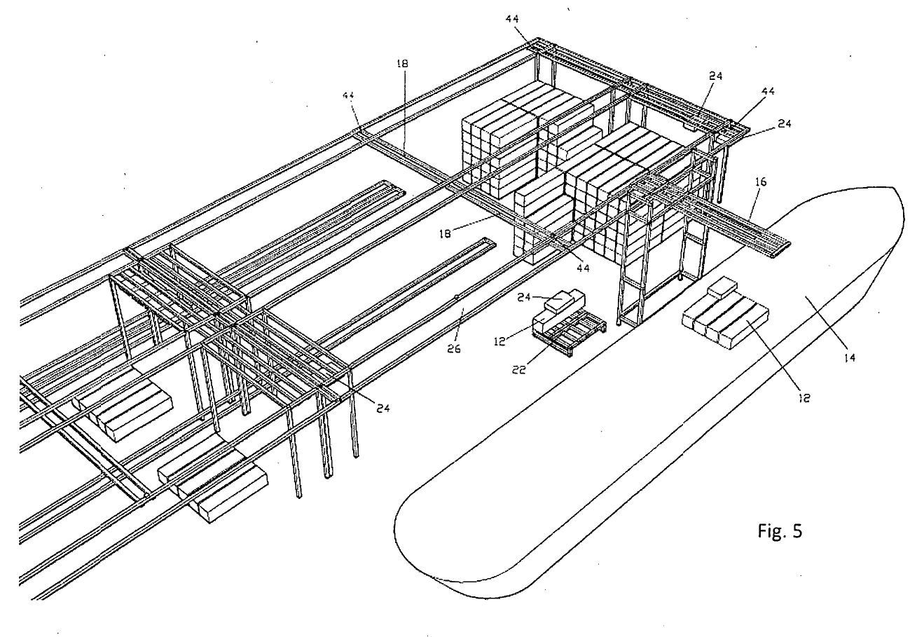

FIG. 5 shows the container carriage 22 with the container 12 moved to the loading point and the first lifting device 24 can lift up the container, at the same time as the unloading crane 16 collects a new container. In that it shall be possible to place the container initially arbitrarily on the container carriage 22, the container carriage 22 can be fitted with appliances to move the container 12, both sideways and lengthwise, so that it gets into the desired collecting position for the lifting device 24.

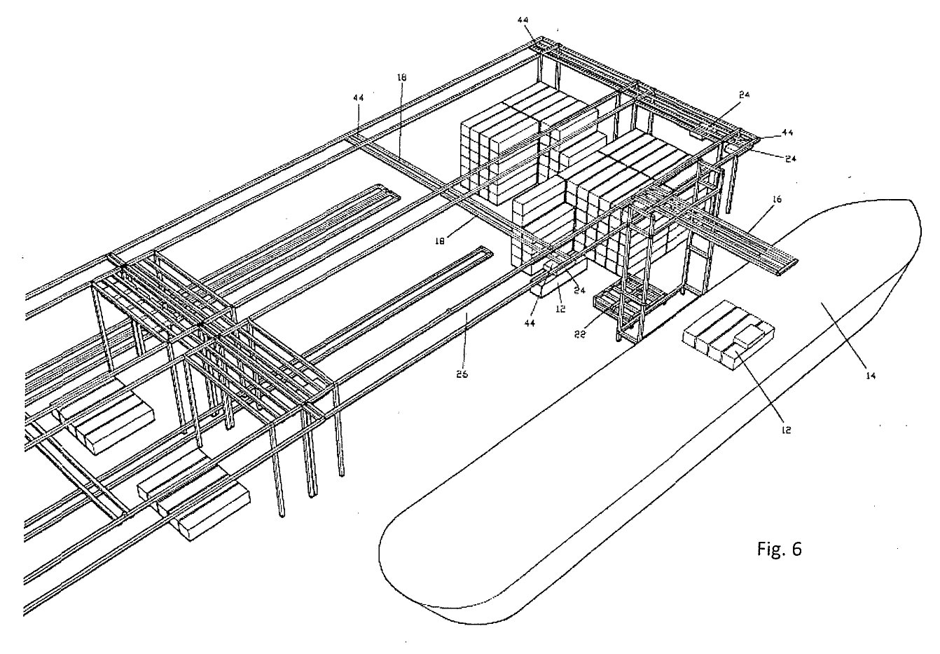

In FIG. 6 the container 12 is lifted up and the first lifting device 24 is ready for transfer to one of the longitudinally running main overhead cranes 18. At the same time a second lifting device 24 is driven out into the lane 26 (to the right in the figure) and the container carriage 22 is driven back to its collecting position.

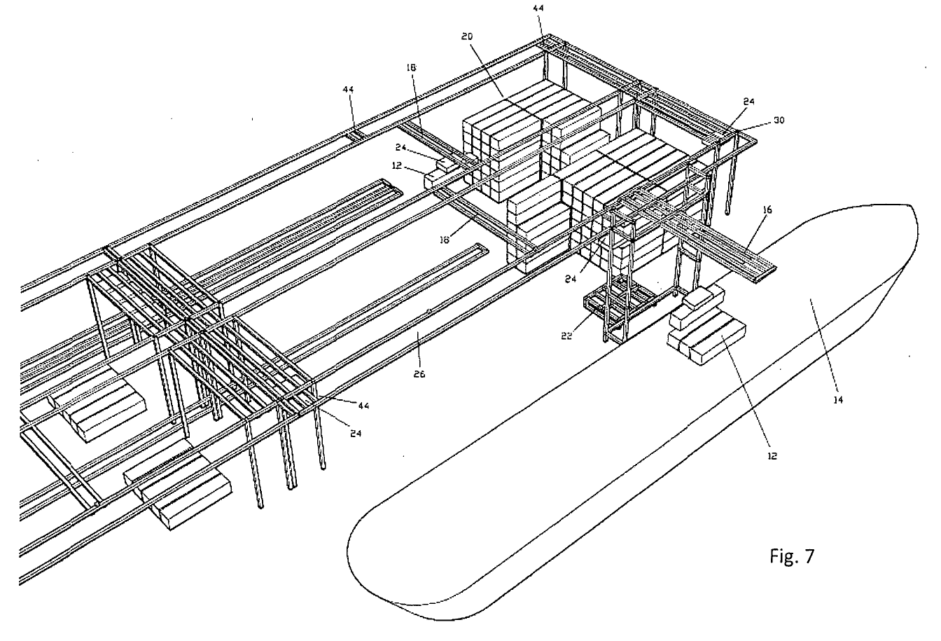

FIG. 7 shows that the first lifting device 24 is transferred to a second main overhead crane 18 for placing the container in the cargo storage 20. The second lifting device 24 arrives (as mentioned from the right) and is driven towards the loading point.

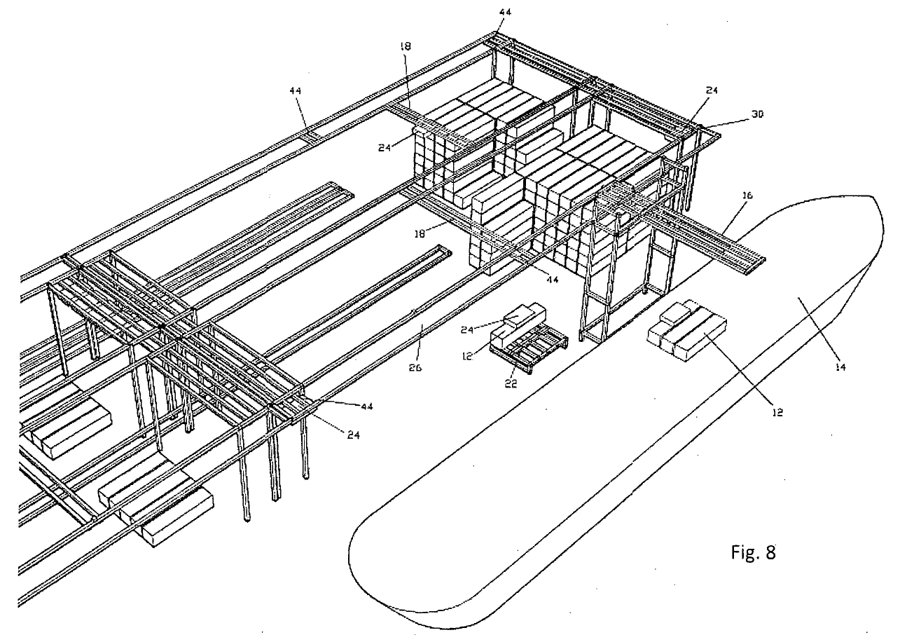

FIG. 8 shows that a new container is unloaded, placed on the container carriage 22 and driven to the loading point. The second lifting device 24 lifts the container 12, while the first lifting device is finished with the placing of its container and is on its way back to a holding position. A third lifting device 24 (to the left in the figure) is driven out and stands ready to be driven in the lane 26 towards the loading point.

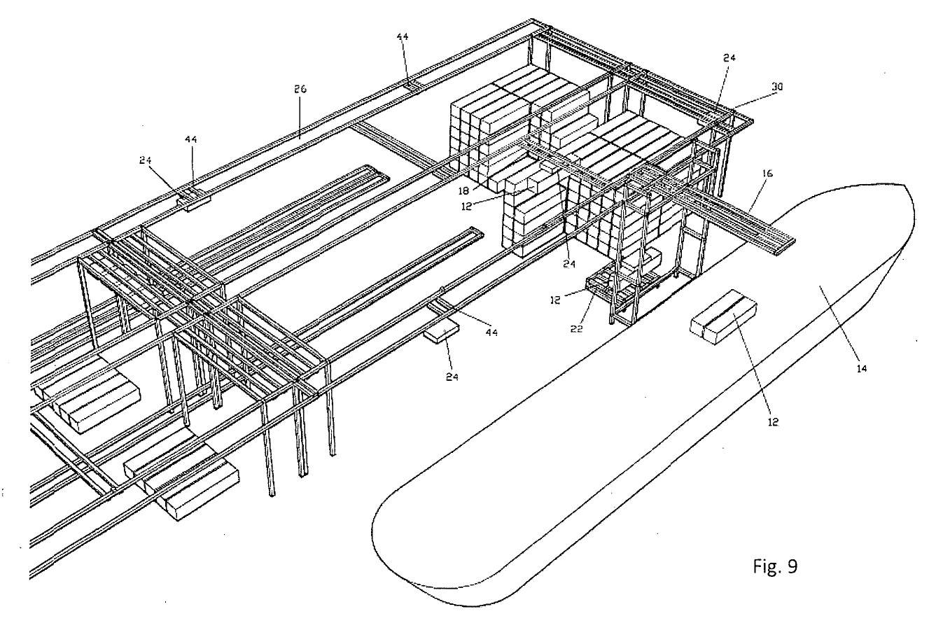

FIG. 9 shows that the first lifting device 24 on the opposite side is on its way back and is driven back with the help of a small overhead auxiliary crane 44, while a second overhead auxiliary crane 44 is driven in the same lane to be ready to receive the second lifting device. The second lifting device 24 is, in FIG. 9, in the process of placing its container in the cargo storage 20 with the help of one of the main overhead cranes 18. At the same time the third lifting device 24 (from left) is driven on the lane 26 towards the loading point, as a new container 12 is transferred to the container carriage 22.

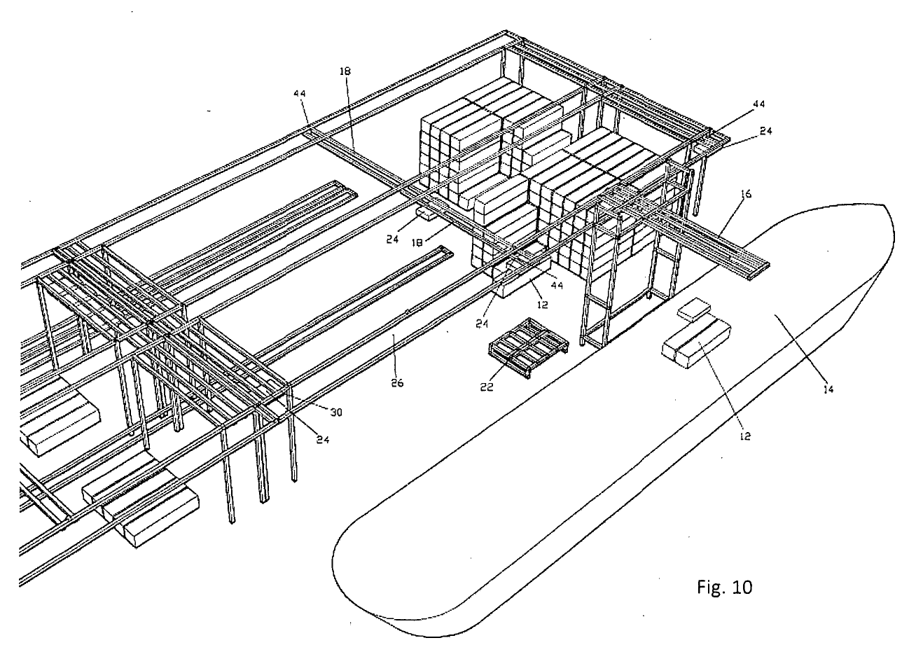

In FIG. 10 the first lifting device 24 is returned to the starting point and stands in a holding location 30 awaiting its turn. The second lifting device 24 has also started its return, while the third lifting device has lifted a container 12 from the container carriage 22. A fourth lifting device 24 is transferred to an overhead auxiliary crane 44 (on the right) and is ready to be driven towards the loading point, while the unloading crane collects a new container from the cargo ship 14.

It is shown in the FIGS. 2-10 that the lifting devices 24 return empty to the holding locations 30, in a so-called single-cycle operation. However, the operation can be double-cycle in that the lifting devices 24 when returning collect containers 12 from the cargo storage 20 and place them on the transport appliances 32 arranged between the cargo storage 20 and the flow-through storage facility 50, and which may extend to the despatching point 60. It is also conceivable that the lifting devices 24 place the containers directly onto the transport appliances 32 for immediate despatching, i.e., without intermediate storage in the cargo storage 20. The transport appliances 32 can be rails or conveyor belts onto which the containers 12 can be moved.

After the unloading is completed the lifting devices 24 can, in a corresponding way, bring the containers to the transport appliances 32 for further transport to the flow-through storage facility 50 and/or to the despatching point 60. A similar system can also be provided for the transport of containers from the flow-through storage facility 50 and to the despatching point 60.

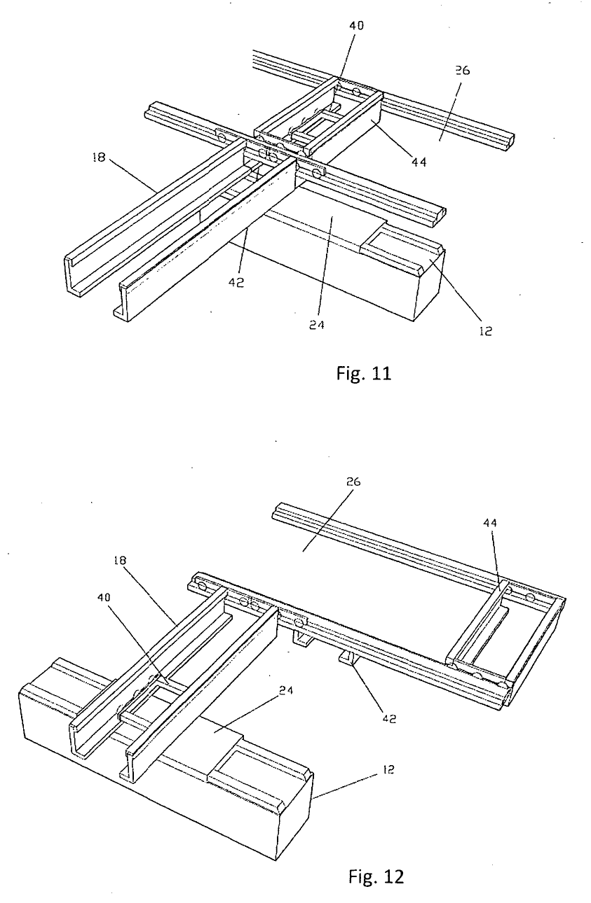

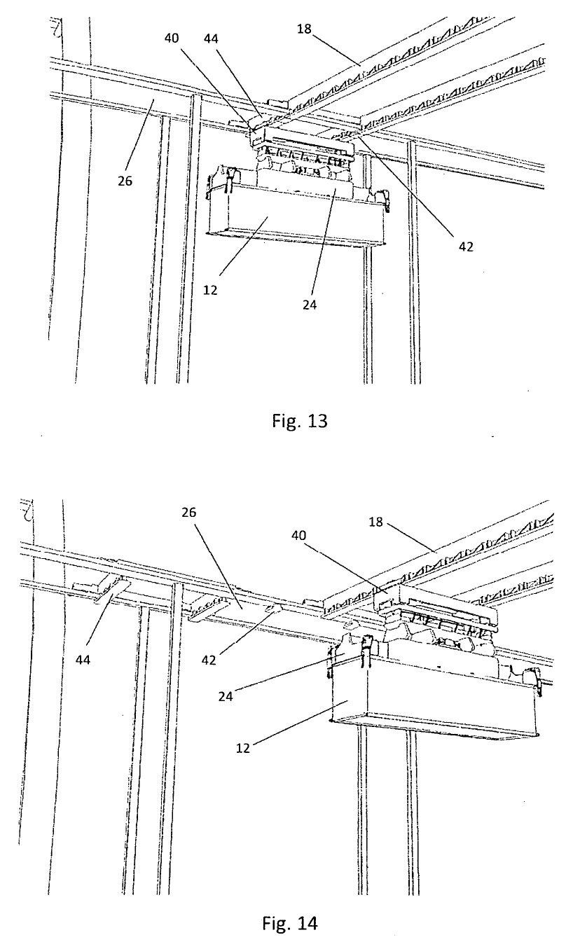

For transfer of the lifting devices 24 from the lane 26 to the cranes 18 that move in the longitudinal direction, the lifting device 24 can be connected to a carriage 40 arranged in a smaller auxiliary crane 44, as shown in the FIGS. 11, 12, 13 and 14. The smaller auxiliary crane 44 runs in said outer lanes 26 which, in the example shown, extend around the whole of the cargo storage 20. The main cranes 18 run as mentioned in the longitudinal direction of the storage facility 10, preferably, for example, on rails placed between the outer lanes 26 and the inner lane 28. Between said outer and inner lanes 26, 28 and the main cranes 18 for the transfer of the lifting device, a transfer device 42 on which the carriage 40 runs is provided, for the transfer of the lifting device 24 with the container 12 to a main crane 18 that moves in a longitudinal direction. This transfer device 42 can, in its simplest form, be underlying rail pieces adjusted so that the carriage 40 can run from the smaller auxiliary crane 44 and over onto one of the main cranes 18 without hindrance. Other transfers of the lifting device can also be provided.

Thus in the example shown, it is the carriage 40, connected to a lifting device 24, which is driven around the facility on the different lanes that are provided. The lifting device 24 itself can be a grab and clamp device that is lowered from the carriage 40, and can be a corresponding grabbing claw which is used in today's harbour trucks for the movement of containers.

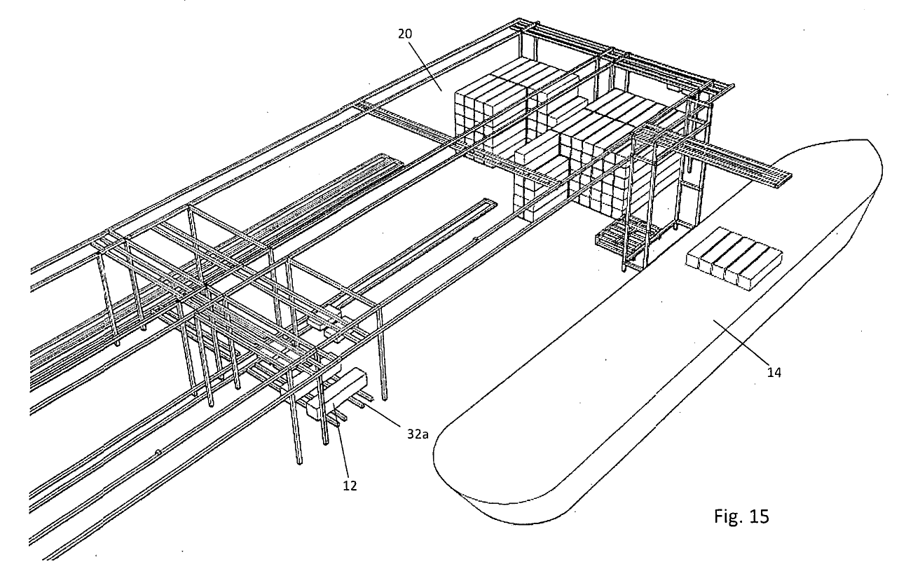

For loading and despatching of containers, the steps described with respect to the figures above 2-10 can be reversed. Furthermore, the containers can be brought to a selected location in the storage facility for transfer to a ship, train, truck, or the like, by opening for despatching of containers or double cycle as shown in FIG. 15 for loading and despatching of containers. The containers 12 shown in FIG. 15 are driven out onto transport appliances 32a, which may be similar to the aforementioned transport appliances 32 or a separate solution, and can be loaded on a ship, train, truck or the like. In connection with unloading and loading of goods it will often be both desirable and beneficial that at the same time as containers or other cargo are unloaded, the new containers for carrying goods are loaded in.

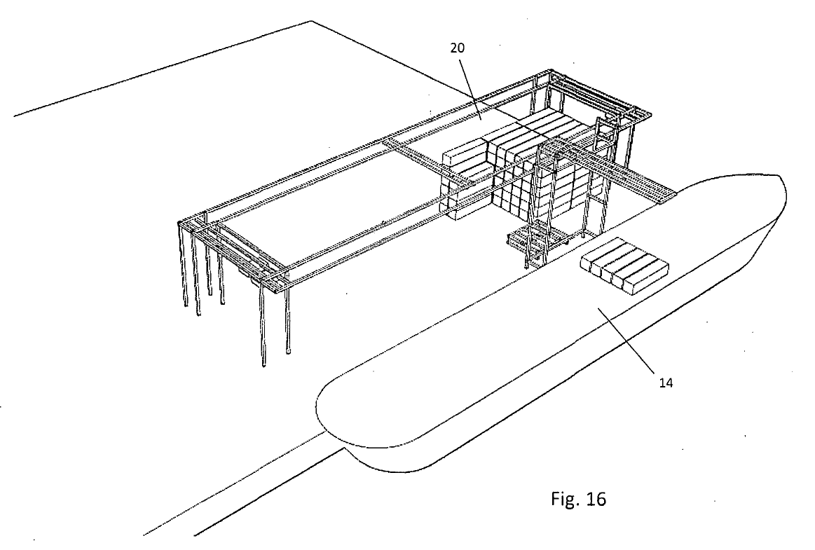

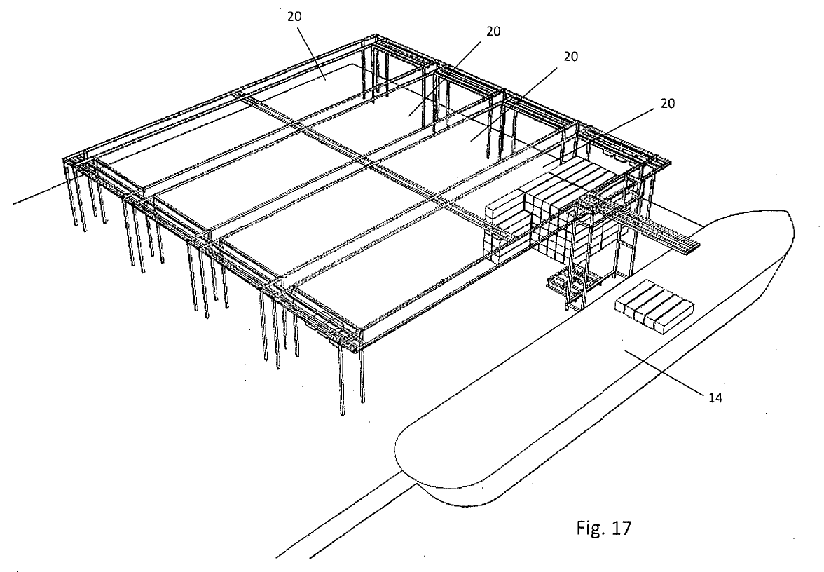

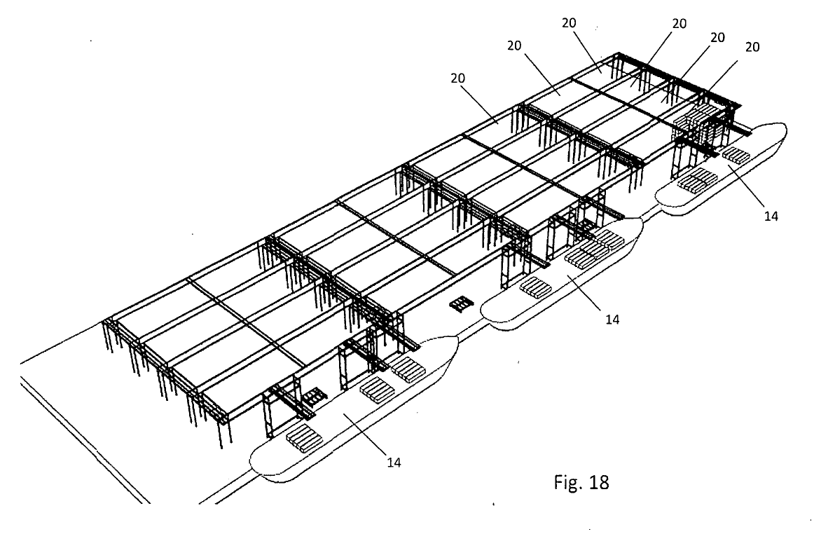

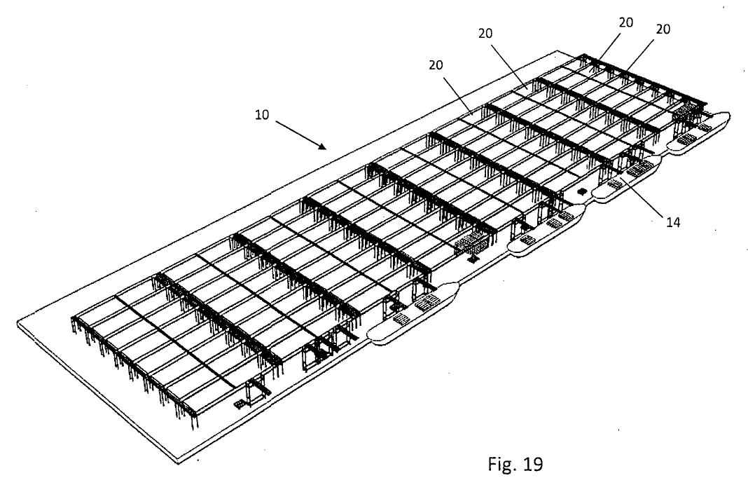

It is previously mentioned that the system can be based on modules, and FIGS. 16 to 19 show examples of this. FIG. 16 shows a single module of the cargo storage 20, corresponding to that previously explained, but here shown with only a single longitudinal main crane 18. FIG. 17 shows four modules placed side by side, i.e., as seen in the figure. FIG. 18 shows 4×4 modules of the cargo storage 20 located adjacent to each other, while FIG. 19 shows an even larger system with 8×8 modules positioned adjacent to each other. All the systems shown in FIGS. 16 to 19 will function according to the same principle as explained above, and in addition the lifting devices can be moved between the different modules for both collecting cargo and despatching cargo to an arbitrary location in the system.

The management of the system is carried out with the help of dedicated computer programmes and management systems, and some examples of management will now be explained in more detail. Other management systems can also be used.

The management of the solution itself is carried out with the help of a suitable management system. The management system can build on the principles of a Warehouse Management System (WMS). The system is responsible for communication to all parts of the solution, i.e., it communicates with cranes, lanes and carriages. The solution is based on modules and one can therefore easily add or remove, for example, a crane or a lane.

The main modules that control the program flow are WMSserver and WMSclient. The WMSserver program controls all movements in the cargo warehouse/system. It receives and carries out transport orders and keeps control of the equipment, cranes, lanes, etc. When the server is started, the cranes will be initialized and the exchange of messages begins between the crane and WMS, at the same time as contact with the clients and the database is set up.

### Management Systems

The automated warehouse is dependent on a management system to be able to carry out its operating tasks. This system can comprise several elements which will be described below.

### PLC

The abbreviation PLC stands for Programmable Logic Controller. This type of control is used to control the motors and other electrical elements such as, for example, hydraulic valves, etc. In this solution the various PLC units will control the cranes, transfers and in/out movements in the lanes. Each PLC can communicate with the WMS over Profinet and to the cranes, via, for example, scalance radio interface.

### WMS

WMS is the part of the computer system which the users come into most contact with in the operation of the automatic warehouse. The system can be comprised of one server and several clients (working terminals). The server has all contacts out to the working terminals and all PLC units, i.e., all the cranes and the lanes.

### Tasks

WMS has overall responsibility for management of the PLC units and thus all the physical components that move in the system. In addition to this WMS shall place and keep track of all containers that are put in and also new containers in and out of the storage facility:
Control of available locations in the warehouse
Communicate with possible overlying ERP systems
Communicate with cranes and lanes via Profinet/WLAN Scalance radio interface.
Control and generate tasks for cranes and lanes

### Receiving Containers:

The containers are placed on the container carriage and are driven up to the loading point which may have a barcode reader or an RFID reader. The pallet is recorded in WMS with its unique identification number. The identification number may have registered information about what is in the container, who owns it, when it should be collected and by whom. WMS selects the location in the storage facility which is optimal in relation to this container. When the system has placed the container at the right location the crane will report a completed task to WMS. In the WMS system one can, at any time, search with the identification number and see where in the storage facility each individual container is placed.

### Despatching Pallets:

Ordering of the containers can be automatically generated either from the WMS system or from an overlying ERP system. The WMS system will start the task and send a message to the cranes to bring out specific containers.

It should be noted that even if expressions such as “at once”, “at the same time” or “while” are used in the description above this does not have to mean that the events happen exactly simultaneously in real time, but is intended only as descriptive. It is the management system described above that controls all the events and when the tasks are carried out.

We claim:

1. A cargo storage for handling of cargo such as containers, comprising:
at least one unloading and loading appliance for unloading and loading of containers from or to a ship, train, truck, or the like,
a framework comprising one or more movable main cranes for placing and retrieving containers in the cargo storage, and where the framework has outer lanes which are arranged in the at least partially surrounding one or more of the main cranes, wherein
several auxiliary cranes in the outer lanes are arranged to move in parallel adjacent to the direction of movement of the main cranes in the framework, and to receive respective lifting devices,
said outer lanes parallel with the main cranes comprises transfer points for transfer of the lifting devices between the auxiliary cranes and said main cranes, and
the lifting devices are arranged to circulate in said outer lanes and return to a holding location.

2. The cargo storage according to claim 1, wherein the outer lane, at the opposite side of the location to the unloading and loading appliance, is arranged to function as a return lane for an empty lifting device to said holding location, in anticipation of a new cycle.

3. The cargo storage according to claim 1, wherein the lifting device is connected to a carriage arranged in the auxiliary crane, and that in said transfer points, lying between said outer lanes and the main cranes, a transfer device on which the carriage runs is provided for the transfer of the lifting device to or from a main crane.

4. The cargo storage according to claim 1, wherein a container carriage is arranged to move between a loading point and the unloading and loading appliance, for transfer of the container to or from one of the circulating lifting devices.

5. The cargo storage according to claim 1, wherein said outer lanes comprise one or more holding locations for lifting devices that are waiting to be picked up by a free smaller auxiliary crane.

6. The cargo storage according to claim 1, wherein said main cranes and auxiliary cranes are designed as longitudinally running overhead cranes which run on a framework.

7. The cargo storage according to claim 4, wherein the container carriage is arranged to receive a container, arbitrarily placed on the container carriage, and to regulate the positioning of the container on the carriage, or the positioning of the carriage so that a container is placed directly below a lifting device before lifting or lowering.

8. A system for unloading and loading of containers from or to a ship, train, truck or the like, comprising several cargo storages for handling of cargo such as containers, wherein said cargo storage comprises:
at least one unloading and loading appliance for unloading and loading of containers from or to a ship, train, truck, or the like,
a framework comprising one or more movable main cranes for placing and retrieving containers in the cargo storage, and where the framework has outer lanes which are arranged in the at least partially surrounding one or more of the main cranes, wherein
several auxiliary cranes in the outer lanes are arranged to move in parallel adjacent to the direction of movement of the main cranes in the framework, and to receive respective lifting devices,
said outer lanes parallel with the main cranes comprises transfer points for transfer of the lifting devices between the auxiliary cranes and said main cranes, and
the lifting devices are arranged to circulate in said outer lanes and return to a holding location.

9. The system according to claim 8, wherein the system is based on modules, as several cargo storages are arranged to be placed adjacent to each other.

10. The system according to claim 9, wherein the lifting devices, with or without load, are arranged to move between the different cargo storages.

11. The system according to claim 9, wherein the system is managed by means of a suitable management system which communicates with all the parts of the installation, such as cranes, lanes, carriages, etc.

12. Method for automation and management of unloading and loading of containers from or to a ship, train, truck or the like to a storage facility, in which containers are unloaded or loaded with the help of at least one unloading and loading appliance, and that the containers are transferred to one or more movable main cranes that run in a framework in the storage facility, for placing and retrieving of a container in a cargo storage, where the framework has outer lanes that are arranged in the at least partially surrounding one or more of the main cranes, wherein the method comprises the following steps:
placement of the container on a container carriage, which stands waiting adjacent to the unloading and loading appliance,
movement of the container carriage to a waiting auxiliary crane, with a lifting device, which stands at a loading point, where said auxiliary crane is arranged to move in the outer lanes, in parallel adjacent to the direction of movement of the main cranes in the framework,
lifting of the container from the container carriage with the help of the lifting device,
transferring of the lifting device with the container from the auxiliary crane to one of the main cranes, for placing the container in the storage facility, and
after the lifting device has delivered the container to the storage facility, the lifting device is driven out in an auxiliary crane on the outer lane, on the opposite side of the loading point, and returns to a holding position, in anticipation of a new cycle.

13. The method according to claim 12, wherein, while the container carriage is moved back adjacent to the unloading and loading appliance for retrieving a new container, a new auxiliary crane is driven with a lifting device up to the loading point for the receipt of a new container.

14. The method according to claim 12, wherein the speed and position of each lifting device is registered so that the lifting devices at any time can be guided to a desired location at a desired time.

15. The method according to claim 12, wherein for loading and despatching of containers the steps specified in one or more of the claims 12-14 are reversed.

16. The method according to claim 12, wherein, for loading and despatching of containers, the containers are brought to a selected location in the storage facility for transfer to a ship, train, truck or the like.
